(19) United States
(12) Patent Application Publication
(10) Pub. No.: US 2011/0158329 A1
(43) Pub. Date: Jun. 30, 2011

(54) SYSTEM AND METHOD FOR BI-PHASE MODULATION DECODING

(76) Inventors: Eric Gregory Oettinger, Rochester, MN (US); Mark David Hagen, Rochester, MN (US); Mark David Heminger, Rochester, MN (US)

(21) Appl. No.: 13/044,930

(22) Filed: Mar. 10, 2011

Related U.S. Application Data
(63) Continuation-in-part of application No. 12/832,674, filed on Jul. 8, 2010.
(60) Provisional application No. 61/289,825, filed on Dec. 23, 2009.

(51) Int. Cl. H04L 27/22; H04B 3/54

(52) U.S. Cl. 375/258; 375/322

(57) ABSTRACT

One embodiment of the present invention includes a decoder system that decodes a bi-phase modulated signal. The system includes a buffer configured to store a first plurality of digital samples associated with a first bit of the bi-phase modulated signal and a second plurality of digital samples associated with a second bit of the bi-phase modulated signal. The first bit can immediately precede the second bit. The system also includes a first summer configured to add the first plurality of digital samples to generate a first sum and a second summer configured to add the second plurality of digital samples to generate a second sum. The system further includes a comparator configured to compare the first sum and the second sum to determine an edge-transition between the first bit and the second bit, and to determine a logic-state of the first bit based on the edge-transition.

### RELATED APPLICATIONS

The present invention is a continuation-in-part application that claims priority from U.S. patent application Ser. No. 12/832,674, filed Jul. 8, 2010, which claims priority from U.S. Provisional Patent Application No. 61/289,825, filed Dec. 23, 2009.

### TECHNICAL FIELD

The present invention relates generally to communications, and specifically to a system and method for bi-phase modulation decoding.

### BACKGROUND

One example of a coding scheme that can be utilized for transferring data is bi-phase modulation. Each bit-window (i.e., period) of a bi-phase modulated signal represents a single logic bit, with each bit-window beginning with a logic-state edge-transition. A logic-low is represented by a substantially constant logic-state through the bit-window, whereas a logic-high is represented by an additional logic-state edge-transition in the approximate center of the bit-window.

When the amplitude of a bi-phase modulated signal is sufficient, any of a variety of different decoding algorithms can be implemented to decode the bi-phase modulated signal. However, as the amplitude of the signal decreases, such as due to filtering and/or transmission medium losses, decoding the bi-phase modulated signal can be difficult based on noise being more likely to appear as valid logic edge-transitions. In addition, in some bi-phase modulated signal transmission implementations, there may be no external clock to align the phase and/or frequency of the bi-phase modulated signal, which can further complicate decoding of the bi-phase modulated signal. Furthermore, when a bi-phase modulated signal is low-pass filtered, such as to remove a carrier frequency, the amplitude of logic-high codes can be attenuated more than logic-low codes that are half the frequency of the logic-high codes.

### SUMMARY

One embodiment of the present invention includes a decoder system that decodes a bi-phase modulated signal. The system includes a buffer configured to store a first plurality of digital samples associated with a first bit of the bi-phase modulated signal and a second plurality of digital samples associated with a second bit of the bi-phase modulated signal. The first bit can immediately precede the second bit. The system also includes a first summer configured to add the first plurality of digital samples to generate a first sum and a second summer configured to add the second plurality of digital samples to generate a second sum. The system further includes a comparator configured to compare the first sum and the second sum to determine an edge-transition between the first bit and the second bit, and to determine a logic-state of the first bit based on the edge-transition.

Another embodiment of the present invention includes a method for decoding a bi-phase modulated signal. The method includes receiving the bi-phase modulated signal via a transmission medium and converting the bi-phase modulated signal from an analog to a digital form comprising a plurality of consecutive digital samples. The method also includes storing the plurality of digital samples in a buffer. The method also includes adding a first portion of the plurality of digital samples to generate a first sum associated with a first bit of the bi-phase modulated signal, and adding a second portion of the plurality of digital samples to generate a second sum associated with a second bit of the bi-phase modulated signal. The second bit can immediately follow the first bit in the bi-phase modulated signal. The method further includes comparing the first sum and the second sum to determine an edge-transition between the first bit and the second bit, and determining a logic-state of the first bit based on the edge-transition relative to an immediately preceding edge-transition between the first bit and an immediately preceding bit.

Another embodiment of the present invention includes a wireless power system. The system includes a portable electronic device comprising a transmitter configured to modulate a bi-phase communication signal onto a secondary current associated with a secondary inductor. The system also includes a wireless charger comprising a receiver configured to monitor a primary current associated with a primary inductor. The primary inductor and secondary inductor collectively form an isolation transformer configured to transfer energy from the primary inductor to the secondary inductor to generate a voltage in the portable electronic device. The receiver includes a decoder that includes a buffer configured to store a first plurality of digital samples associated with a second half of a total number of samples of a first bit of the bi-phase modulated signal and a second plurality of digital samples associated with a second half of a total number of samples of a second bit of the bi-phase modulated signal. The first bit can immediately precede the second bit. The decoder can also include a first summer configured to add the first plurality of digital samples to generate a first sum and a second summer configured to add the second plurality of digital samples to generate a second sum. The decoder can further include a comparator configured to compare the first sum and the second sum to determine an edge-transition between the first bit and the second bit, and to determine a logic-state of the second bit based on comparing the edge-transition with a previous edge-transition between the first bit and an immediately preceding bit.

### BRIEF DESCRIPTION OF THE DRAWINGS

FIG. 1 illustrates an example of a bi-phase modulation decoder in accordance with an aspect of the invention.

FIG. 2 illustrates an example of a graph of a set of filter taps in accordance with an aspect of the invention.

FIG. 3 illustrates another example of a graph of a set of filter taps in accordance with an aspect of the invention.

FIG. 4 illustrates another example of a bi-phase modulation decoder in accordance with an aspect of the invention.

FIG. 5 illustrates an example of a wireless power system in accordance with an aspect of the invention.

FIG. 6 illustrates an example of a method for decoding a bi-phase modulated signal in accordance with an aspect of the invention.

FIG. 7 illustrates yet another example of a bi-phase modulation decoder in accordance with an aspect of the invention.

FIG. 8 illustrates an example diagram of decoding a bi-phase modulated signal in accordance with an aspect of the invention.

FIG. 9 illustrates another example diagram of decoding a bi-phase modulated signal in accordance with an aspect of the invention.

FIG. 10 illustrates yet another example diagram of decoding a bi-phase modulated signal in accordance with an aspect of the invention.

FIG. 11 illustrates another example of a method for decoding a bi-phase modulated signal in accordance with an aspect of the invention.

### DETAILED DESCRIPTION

The present invention relates generally to communications, and specifically to a system and method for bi-phase modulation decoding. A bi-phase modulation decoder can include at least one filter that is associated with the logic-low state, at least one filter that is associated with the logic-high state, and a comparator. As an example, the filters can be finite impulse response (FIR) filters. A bi-phase modulated signal having a plurality of digital samples can be provided to each of the filters associated with each of the logic-low and logic-high states. The filters can be programmed with a plurality of taps that have tap weights with a range of values that are normalized with respect to each other. As an example, the values can be integer or floating point values. The filters can thus each generate a statistical value, such as a dot product, of the digital samples of the bi-phase modulated signal with respect to the plurality of taps. The comparator can thus compare an absolute value of the dot products that are generated by the filters to determine if a given bi-phase modulated code corresponds to a logic-low or a logic-high.

The range of values associated with the tap weights of the plurality of taps for a given filter can be programmed with specific values that result in a dot product that is more indicative of a logic-state that is specific to the filter. As an example, filters that are associated with a logic-low can be programmed such that the tap weights have a range of values that can be plotted as an approximate half sine wave across the taps of the filters, such that the values can all be greater than a reference value (e.g., zero). Therefore, an absolute value of a dot product of a logic-low coded bi-phase modulated signal can be much greater in the logic-low filter than a logic-high coded bi-phase modulated signal.

As another example, filters that are associated with a logic-high can be programmed such that the tap weights have a range of values that can be plotted as an approximate sine wave across the plurality of taps of the filters. Specifically, the values for the filter associated with the logic-high can have a first portion of taps corresponding to consecutive digital samples with values greater than the reference value and a second portion of taps corresponding to consecutive digital samples with values less than the reference value. Accordingly, an absolute value of a dot product of a logic-high coded bi-phase modulated signal can be much greater in the logic-high filter than a logic-low coded bi-phase modulated signal.

The bi-phase modulation decoder can include additional filters associated with each of the logic-states with distinct numbers of taps. For example, for each logic-state, the bi-phase modulation decoder can include a first filter having a number N of taps, where N is a positive integer corresponding to an expected number of digital samples of the bi-phase modulation decoder, a second filter having N+1 taps, and a third filter having N−1 taps. The tap weights of the six filters can be programmed to be normalized relative to each other. Therefore, the bi-phase modulation decoder can not only determine the code of the bi-phase modulated signal, but can also detect and account for frequency variation and jitter present in the bi-phase modulated signal. Specifically, the filter having the highest absolute value dot product not only determines the code of the bi-phase modulated signal, but also determines the number of samples of a given bit-window of the bi-phase modulated signal, and thus a frequency variation of the bi-phase modulated signal. As a result, the bi-phase modulation decoder can select two of the filters having the appropriate number of taps that correspond to the number of digital samples of a bit-window for subsequent decoding of the bi-phase modulated signal.

As another example, the bi-phase modulation decoder can include a buffer that stores the digital samples of the bi-phase modulated signal. The bi-phase modulation decoder can employ a pair of summers that each add together a portion of the digital samples that correspond to a first bit and a second bit, respectively, where the first bit immediately precedes the second bit. As an example, the first summer can add together a set of digital samples corresponding to a second half of the total samples that constitute the first bit and the second summer can add together a set of digital samples corresponding to a first half of the total samples that constitute the second bit. The bi-phase modulation decoder can include a comparator that compares the two sums to determine an edge-transition. As described herein, an edge-transition is defined as a transition of digital samples corresponding to one of an approximately logic-high state and an approximately logic-low state switching to the other of the approximately logic-high state and the approximately logic-low state. Therefore, the edge-transition corresponds to one of a rising-edge and a falling-edge of the bi-phase modulation signal.

The determined edge-transition can be compared with an immediately preceding edge-transition to determine the logic-state of the second bit. The immediately preceding edge-transition can thus correspond to the edge-transition between the first bit and an immediately preceding bit in the bi-phase modulation signal. Thus, if the determined edge-transition is the same as the immediately preceding edge-transition (i.e., both logic-high or both logic-low), then the code corresponding to the second bit corresponds to a logic-high state. However, if the determined edge-transition is the opposite of the immediately preceding edge-transition (i.e., one is logic-high and one is logic-low), then the code corresponding to the second bit corresponds to a logic-low state.

In addition, the bi-phase modulation decoder can include an integrator that is configured to determine the samples that correspond to each of the first and second bits to be used for the sums and comparison. Specifically, the integrator can determine a location of the edge-transition between two consecutive digital samples amongst the digital samples stored in the buffer. The integrator can then determine the number of samples that correspond to a given bit (e.g., the first bit), and can designate which samples stored in the buffer correspond to the first bit and the second bit, respectively, for the purposes of the summations for the comparison. Thus, the integrator can manipulate the samples in the buffer to ensure that the sums are equivalent for an accurate comparison, such that the edge-transition can be accurately determined.

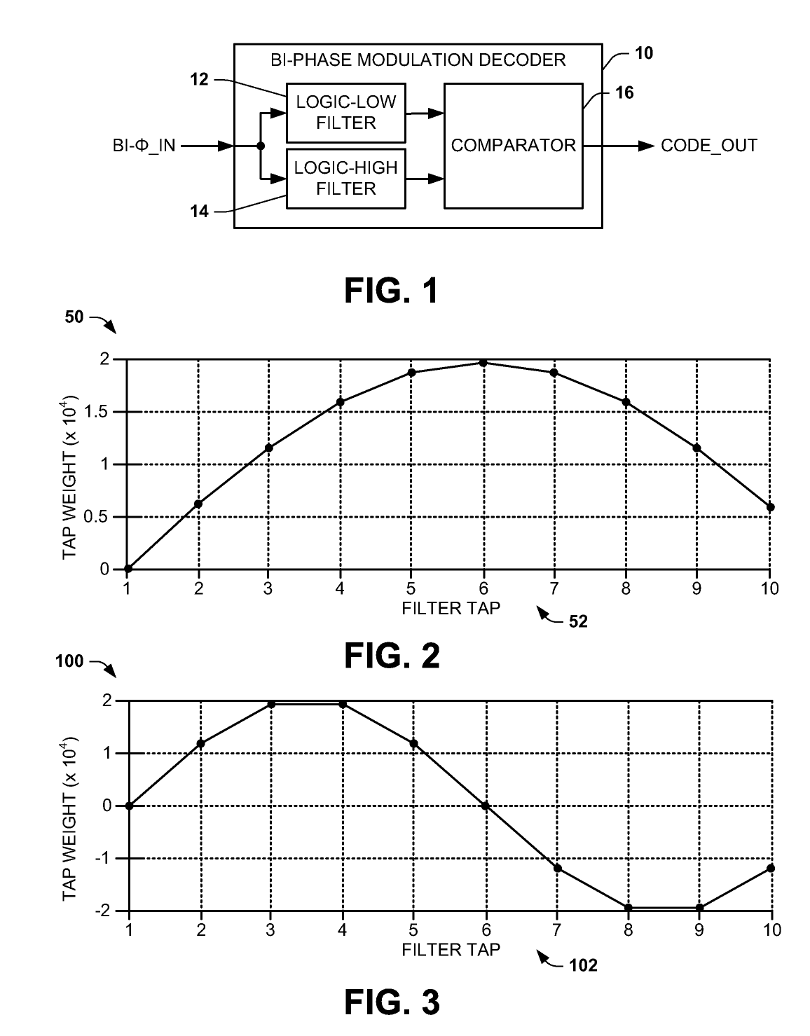

FIG. 1 illustrates a bi-phase modulation decoder 10 in accordance with an aspect of the invention. The bi-phase modulation decoder 10 is configured to receive a bi-phase modulated signal BI-Φ_IN and to decode the bi-phase modulated signal BI-Φ_IN to generate an output code CODE_OUT. Each bit-window of the bi-phase modulated signal BI-Φ_IN can represent a single logic bit, with each bit-window beginning with a logic-state edge-transition. A logic-low can be represented by a substantially constant logic-state through the bit-window, whereas a logic-high can be represented by an additional logic-state edge-transition in the approximate center of the bit-window. The bi-phase modulation decoder 10 can be implemented in any of a variety of electronic communications applications. As an example, the bi-phase modulation decoder 10 can be included in a receiver in a wireless power application.

The bi-phase modulated decoder 10 includes a logic-low filter 12 corresponding to a logic-low, a logic-high filter 14 corresponding to a logic-high, and a comparator 16. As an example, the logic-low filter 12 and the logic-high filter 14 can be configured as finite impulse response (FIR) filters. In the example of FIG. 1, the bi-phase modulated signal BI-Φ_IN is provided to both of the logic-low filter 12 and the logic-high filter 14. For a given bit-window of the bi-phase modulated signal BI-Φ_IN, the logic-low filter 12 and the logic-high filter 14 each generate a statistical value, such as a dot product, of digital samples of the bi-phase modulated signal BI-Φ_IN relative to a respective plurality of tap weights of the respective one of the logic-low filter 12 and the logic-high filter 14. The digital samples of the bi-phase modulated signal BI-Φ_IN can be received at each of the logic-low filter 12 and the logic-high filter 14 at a substantially constant frequency. As an example, the digital samples of the bi-phase modulated signal BI-Φ_IN can be buffered, such that the bi-phase modulation decoder 10 can decode each bit-window of the bi-phase modulated signal BI-Φ_IN as they are received. The logic-low filter 12 and the logic-high filter 14 each provide the respective dot products to the comparator 16, which compares an absolute value magnitude of each of the dot products to determine if the given bit-window of the bi-phase modulated signal BI-Φ_IN corresponds to a logic-low code or a logic-high code.

As described above, a bit-window of the bi-phase modulated signal BI-Φ_IN that is coded with a logic-low state can have an approximately constant magnitude (i.e., high or low) across the entire bit-window, and a bit-window of the bi-phase modulated signal BI-Φ_IN that is coded with a logic-high state can have an additional logic-state edge-transition in the approximate center of the bit-window. Because the bi-phase modulated signal BI-Φ_IN can be low-pass filtered prior to being received at the bi-phase modulation decoder 10, the logic-state edge-transitions of the bi-phase modulated signal BI-Φ_IN can be gradual. Therefore, a bit-window of the bi-phase modulated signal BI-Φ_IN that is coded with a logic-low state can resemble an approximate half sine wave and a bit-window of the bi-phase modulated signal BI-Φ_IN that is coded with a logic-high state can resemble an approximate sine wave. Therefore, each of the logic-low filter 12 and the logic-high filter 14 can include a plurality of taps that are programmed with tap weights having values that can be plotted to correspond to the respective coded logic-state of a bit-window of the bi-phase modulated signal BI-Φ_IN. As an example, the values can be integer values or floating point values.

For example, the tap weights of the logic-low filter 12 can be programmed with a range of values that can be plotted as an approximate half sine wave across the plurality of taps of the logic-low filter 12, such that the values can all be greater than a reference value (e.g., zero). As another example, the logic-high filter 14 can be programmed such that the tap weights have a range of values that can be plotted as an approximate sine wave across the plurality of taps of the logic-high filter 14. Specifically, the values for the logic-high filter 14 can have a first portion of taps corresponding to consecutive digital samples with values greater than the reference value and a second portion of taps corresponding to consecutive digital samples with values less than the reference value. It is to be understood that, for the logic-high filter 14, the sine wave can be plotted with a phase of 0° or 180°, such that the portions of the taps that are greater than and less than the reference value, respectively, can be reversed.

FIG. 2 illustrates an example of a graph 50 of a set of filter taps 52 in accordance with an aspect of the invention. As an example, the filter taps 52 can be filter taps associated with the logic-low filter 12 in the example of FIG. 1. The graph 50 is demonstrated in the example of FIG. 2 as plotting tap weights across ten filter taps 52, numbered 1 through 10 in the example of FIG. 2. Similar to as described above, the tap weights of the logic-low filter 12 are demonstrated as being plotted as an approximate half sine wave across the filter taps 52, with the tap weights of all of the filter taps 52 having a magnitude that is greater than a reference value of 0. In the example of FIG. 2, the filter taps are demonstrated as having been programmed with a set of integer tap weights that are approximately represented as {0, 6180, 11756, 16180, 19021, 20000, 19021, 16180, 11756, 6180}. It is to be understood that, in the example of FIG. 2, the tap weights are demonstrated as interconnected by lines to demonstrate the plotting of the tap weights as an approximate half sine wave.

FIG. 3 illustrates an example of a graph 100 of a set of filter taps 102 in accordance with an aspect of the invention. As an example, the filter taps 102 can be filter taps associated with the logic-high filter 14 in the example of FIG. 1. The graph 100 is demonstrated in the example of FIG. 3 as plotting tap weights across ten filter taps 102, numbered 1 through 10 in the example of FIG. 3. Similar to as described above, the tap weights of the logic-high filter 14 are demonstrated as being plotted as an approximate sine wave across the filter taps 102. Specifically, the tap weights of a first portion of the filter taps 102 numbered 2 through 5 have a value that is greater than the reference value of 0, and the tap weights of a second portion of the filter taps 102 numbered 7 through 10 have a value that is less than the reference value of 0 and which are equal and opposite the first portion. In the example of FIG. 3, the filter taps are demonstrated as having been programmed with a set of tap weights that are approximately represented as {0, 11756, 19021, 19021, 11756, 0, −11756, −19021, −19021, −11756}. It is to be understood that, in the example of FIG. 3, the tap weights are demonstrated as interconnected by lines to demonstrate the plotting of the tap weights as an approximate sine wave. In addition, as demonstrated by the range of tap weight values in the graph 100 relative to the graph 50, the tap weights for each of the logic-low filter 12 and the logic-high filter 14 are normalized with respect to each other to provide comparable dot products to the comparator 16.

Referring back to the example of FIG. 1, the logic-low filter 12 and the logic-high filter 14 each generate a dot product of digital samples of the bi-phase modulated signal BI-Φ_IN and the tap weights 52 and 102, respectively. To generate the dot product, each consecutive digital sample of the bi-phase modulated signal BI-Φ_IN is multiplied by the respective consecutive filter taps 52 and 102, with all of the products being summed together. Therefore, for each bit-window of the bi-phase modulated signal BI-Φ_IN, the comparator 16 receives the respective dot products being provided by the logic-low filter 12 and the logic-high filter 14. Based on the programmed tap weights for the taps 52 and 102, the dot product that is generated by the given one of the logic-low filter 12 and the logic-high filter 14 that corresponds to the encoded logic-state of the bit-window of the bi-phase modulated signal BI-Φ_IN will have an absolute value that is much greater than the other one of the logic-low filter 12 and the logic high filter 14. Accordingly, the comparator 16 can easily identify and output the encoded logic-state of the bit-window of the bi-phase modulated signal BI-Φ_IN as the digital output signal CODE_OUT based on a simple determination of which of the dot products output from the logic-low filter 12 and the logic-high filter 14 has a greater absolute value.

As an example, the bi-phase modulated signal BI-Φ_IN can have a frequency of 2 kHz and can be sampled at a frequency of 20 kHz by an analog-to-digital converter (ADC; not shown). Thus, the bi-phase modulation decoder 10 receives ten digital samples of the bi-phase modulated signal BI-Φ_IN corresponding to a single bit-window, and thus an encoded logic-state. For example, the ten digital samples are numerically represented as the set {162, 646, 594, 670, −23, −642, −778, −804, −674, −280}. The digital samples are provided to each of the logic-low filter 12 and the logic-high filter 14, and each of the logic-low filter 12 and the logic-high filter 14 generate a dot product of the ten digital samples and the respective set of tap weights of the taps 52 and 102. Based on the tap weights for the taps 52 and 102 demonstrated in the examples of FIGS. 2 and 3, respectively, the logic-low filter 12 generates an absolute value dot product of 28,922,541 and the logic-high filter 14 generates an absolute value dot product of 71,917,418. Therefore, the comparator 16 determines that the ten digital samples of the bi-phase modulated signal BI-Φ_IN correspond to a logic-high based on the absolute value of the dot product generated by the logic-high filter 14 being greater than the dot product being generated by the logic-low filter 12. Accordingly, the comparator 16 outputs the signal CODE_OUT as a logic-high.

The bi-phase modulation decoder 10 is therefore capable of accurately decoding the bi-phase modulation signal BI-Φ_IN, regardless of an attenuated amplitude that can result from filtering and/or transmission medium losses. Specifically, even at very low amplitudes, such that noise could typically degrade accurate decoding of the bi-phase modulated signal BI-Φ_IN, the bi-phase modulation decoder 10 can still accurately decode the bi-phase modulated signal BI-Φ_IN based on the operation of the logic-low filter 12, the logic-high filter 14, and the comparator 16. In addition, the bi-phase modulation decoder 10 can accurately decode the bi-phase modulated signal BI-Φ_IN even in the presence of a direct current (DC) component of the bi-phase modulated signal BI-Φ_IN based on the simple comparison operation of the comparator 16. Furthermore, the weighting provided by the tap values of the taps 52 and 102 of the logic-low filter 12 and the logic-high filter 14, respectively, provides better signal-to-noise ratio (SNR) than simple zero-crossing detection algorithms for decoding the bi-phase modulated signal BI-Φ_IN that is subjected to noise and/or asymmetry.

It is to be understood that the bi-phase modulation decoder 10 is not intended to be limited to the examples of FIGS. 1 through 3. For example, because the bi-phase modulation decoder 10 operates in the digital domain, the bi-phase modulation decoder 10 can be implemented as software or a combination of hardware and software. Specifically, the bi-phase modulation decoder 10 can be configured in or in a portion of an integrated circuit (IC). As another example, the logic-low and logic-high filters 12 and 14 are not limited to generating a dot product, but other types of statistical values that associate the digital samples of the bi-phase modulated signal BI-Φ_IN with the taps of the logic-low and logic-high filters 12 and 14 can be implemented. Furthermore, it is to be understood that the tap weights for the taps 52 and 102 are not intended to be limited to the range of values demonstrated in the examples of FIGS. 2 and 3, respectively. For example, the tap weights for the taps 52 and 102 could instead more closely resemble square waves as opposed to the more gradual changes in values between taps 52 and 102 demonstrated in the examples of FIGS. 2 and 3, or could instead have inverted magnitudes relative to the common reference value of zero. Therefore, the bi-phase modulation decoder 10 can be configured in any of a variety of ways.

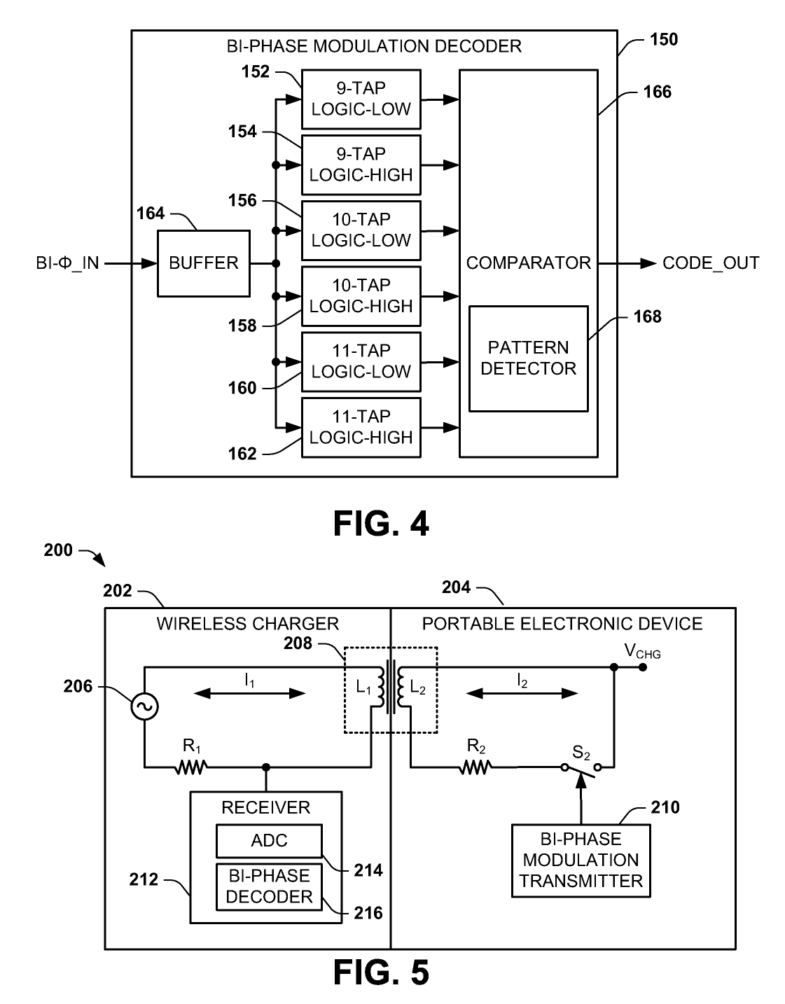

FIG. 4 illustrates another example of a bi-phase modulation decoder 150 in accordance with an aspect of the invention. Similar to the bi-phase modulation decoder 10 in the example of FIG. 1, the bi-phase modulation decoder 150 is configured to receive digital samples of the bi-phase modulated signal BI-Φ_IN and to decode the bi-phase modulated signal BI-Φ_IN to generate an output code CODE_OUT.

The bi-phase modulation decoder 150 includes a plurality of logic-low filters that each have a distinct number of taps and a plurality of logic-high filters that each have the distinct number of taps. Specifically, the bi-phase modulation decoder 150 includes a 9-tap logic-low filter 152, a 9-tap logic-high filter 154, a 10-tap logic-low filter 156, a 10-tap logic-high filter 158, an 11-tap logic-low filter 160, and an 11-tap logic-high filter 162. As an example, the filters 152 through 162 can be configured as FIR filters. In the example of FIG. 4, the digital samples of the bi-phase modulated signal BI-Φ_IN are provided to a buffer 164 that buffers 11 digital samples of the bi-phase modulated signal BI-Φ_IN at a time. The digital samples are then provided from the buffer to all of the filters 152 through 162, such that for a given bit-window of the bi-phase modulated signal BI-Φ_IN, the filters 152 through 162 each generate a dot product of digital samples of the bi-phase modulated signal BI-Φ_IN and a respective plurality of tap weights of the filters 152 through 162.

Similar to the logic-low filter 12 in the example of FIG. 1, each of the logic-low filters 152, 156, and 160 can be programmed with a range of values that can be plotted as an approximate half sine wave across 9, 10, and 11 taps, respectively, similar to as demonstrated in the example of FIG. 2. In addition, similar to the logic-low filter 14 in the example of FIG. 1, each of the logic-high filters 154, 158, and 162 can be programmed with a range of values that can be plotted as an approximate sine wave across 9, 10, and 11 taps, respectively, similar to as demonstrated in the example of FIG. 3. Furthermore, the tap weights of the filters 152 through 162 can all be normalized with respect to each other, such that all six of the filters 152 through 162 yield appropriately comparable dot products. Specifically, the normalization of the tap weights of the filters 152 through 162 can be such that the absolute value dot products can be comparable such that they do not provide an inherent advantage with respect to a sine wave plot versus half sine wave plot, or with respect to the number of taps of the respective filters 152 through 162. As an example, the tap weights in the 9-tap filters 152 and 154 can be greater than the tap weights in the 10-tap filters 156 and 158 and tap weights in the 11-tap filters 160 and 162 can be less than the tap weights in the 10-tap filters 156 and 158 based on the varying number of terms in the absolute value dot products. The bi-phase modulation decoder 150 thus also includes a comparator 166, which compares an absolute value magnitude of each of the dot products to determine if the given bit-window of the bi-phase modulated signal BI-Φ_IN corresponds to a logic-low code or a logic-high code. The comparator 166 thus outputs the output signal CODE_OUT as either a logic-low or a logic-high based on the comparison.

Ideally, the frequency of the bi-phase modulation signal BI-Φ_IN and the sampling frequency of the associated ADC (not shown) that provides the digital samples of the bi-phase modulated signal BI-Φ_IN are aligned. Therefore, the bi-phase modulation decoder 150 can appropriately anticipate a set number of digital samples to correspond to one bit-window of the bi-phase modulation signal BI-Φ_IN. However, the associated communication system may not include an external clock to align the frequencies of the bi-phase modulated signal BI-Φ_IN and the sampling frequency of the ADC. Thus, frequency variation and/or jitter can be introduced into the associated communication system from any of a variety of factors. Therefore, the number of samples that can correspond to a given bit-window of the bi-phase modulation signal BI-Φ_IN may vary based on the frequency variation and/or jitter. Specifically, a frequency of the bi-phase modulation signal BI-Φ_IN that is greater than the expected frequency can result in a number of digital samples that is less than the expected number of samples for a given bit-window. Similarly, a frequency of the bi-phase modulation signal BI-Φ_IN that is less than the expected frequency can result in a number of digital samples that is greater than the expected number of samples.

In the example of FIG. 4, the bi-phase modulated signal BI-Φ_IN can have a frequency of 2 kHz and can be sampled at a frequency of 20 kHz by the ADC. Thus, it is expected that the bi-phase modulation decoder 150 receives ten digital samples of the bi-phase modulated signal BI-Φ_IN corresponding to a single bit-window, and thus an encoded logic-state. Thus, the 10-tap logic-low and logic-high filters 156 and 158 have a number of taps equal to the expected number of digital samples for a given bit-window of the bi-phase modulated signal BI-Φ_IN. However, frequency variation and/or jitter resulting in a frequency greater than 2 kHz can result in each bit-window of the bi-phase modulated signal BI-Φ_IN having 9 digital samples or resulting in a frequency less than 2 kHz can result in each bit-window of the bi-phase modulated signal BI-Φ_IN having 11 digital samples. Therefore, the 9-tap logic-low and logic-high filters 152 and 156 and the 11-tap logic-low and logic-high filters 160 and 162 have a number of taps corresponding to 9 and 11 digital samples, respectively, for a given bit-window of the bi-phase modulated signal BI-Φ_IN based on the frequency variation and/or jitter.

The 9-tap logic-low and logic-high filters 152 and 154 each generate a dot product of the first 9 digital samples provided from the buffer 164 with 9 respective tap weights. The 10-tap logic-low and logic-high filters 156 and 158 each generate a dot product of the first 10 digital samples provided from the buffer 164 with 10 respective tap weights. The 11-tap logic-low and logic-high filters 160 and 162 each generate a dot product of all 11 digital samples provided from the buffer 164 with 11 respective tap weights. The comparator 166 thus not only determines the encoded logic-state of the bit-window of the bi-phase modulated signal BI-Φ_IN based on the greatest absolute value of the respective six dot products, but also determines the size of the given bit-window. Specifically, the greatest absolute value magnitude dot product is also determinative of the number of digital samples that constituted the bit-window of the bi-phase modulated signal BI-Φ_IN based on which of the six filters 152 through 162 generated the greatest magnitude absolute value dot product. Accordingly, the bi-phase modulation decoder 150 can accurately decode the bi-phase modulated signal BI-Φ_IN without an external clock that accounts for frequency variation and/or jitter.

As an example, if the comparator 166 determines that the bit-window had a length of less than the eleven digital samples output from the buffer 164, then the comparator 166 identifies that the last one or two digital samples of the eleven digital samples output from the buffer 164 thus correspond to the next bit-window of the bi-phase modulated signal BI-Φ_IN. For example, upon determining that the absolute value dot product of the 9-tap logic-high filter 154 is the highest, the comparator determines that the bit-window of the encoded logic-high is 9 digital samples long. Therefore, the remaining two digital samples of the 11 samples output from the buffer 164 correspond to the first two digital samples of the next bit-window of the bi-phase modulated signal BI-Φ_IN. As a result, the buffer 164 can be commanded by the comparator 166 to collect only the next nine samples of the bi-phase modulated signal BI-Φ_IN to provide a next set of eleven samples to the filters 152 through 162 for decoding the next bit-window.

In the example of FIG. 4, the comparator 166 includes a pattern detector 168. As an example, the pattern detector 168 can be configured as an algorithm that detects patterns in the number of digital samples that correspond to each decoded bit-window of the bi-phase modulated signal BI-Φ_IN. Thus, upon determining a given pattern, the pattern detector 168 can instruct the comparator 166 to only evaluate the relevant logic-low and logic-high pair of the filters 152 through 162 for each subsequent bit-window. For example, the pattern detector 168 could determine that the bi-phase modulated signal BI-Φ_IN has an average bit length of approximately 9.75 digital samples based on a recurring pattern of 9, 10, 10, and 10 digital samples. Therefore, the pattern detector 168, upon determining this pattern, can instruct the comparator 166 to evaluate only the 9-tap logic-low and logic-high filters 152 and 154 every fourth bit-window, and to evaluate only the 10-bit logic-low and logic-high filters 156 and 158 the remaining bit windows. As a result, the bi-phase modulation decoder 150 can reduce a number of machine instructions upon detecting a bit-window length pattern.

It is to be understood that the bi-phase modulation decoder 150 is not intended to be limited to the example of FIG. 4. For example, similar to the bi-phase modulation decoder 10 in the example of FIG. 1, the bi-phase modulation decoder 10 can be implemented as software or a combination of hardware and software. In addition, the bi-phase modulation decoder 150 is not limited to the six filters 152 through 162, but can include more or less filters based on the range of frequency variation and/or machine instructions per second (MIPS) constraints. As an example, the bi-phase modulation decoder 150 can include ten filters ranging in tap size from eight taps to twelve taps to account for a wider variation in frequency variation. As another example, the bi-phase modulation decoder 150 can include four filters having a programmable number of taps. Thus, upon the bi-phase modulation decoder 150 detecting an average number of digital samples corresponding to the size of the bit-window, such as via a zero-crossing algorithm on a preamble of the bi-phase modulated signal BI-Φ_IN, the four filters can be programmed with the appropriate number of taps (e.g., 9 and 10 taps, respectively, for a 9.75 average sample length bit-window) for decoding the bi-phase modulated signal BI-Φ_IN. Accordingly, the bi-phase modulation decoder 150 can be configured in any of a variety of ways.

FIG. 5 illustrates an example of a wireless power system 200 in accordance with an aspect of the invention. The wireless power system 200 includes a wireless charger 202 and a portable electronic device 204. As an example the portable electronic device 204 can be a wireless communication device. In the example of FIG. 5, the wireless charger 202 includes a current supply 206 that generates a current I₁ through an inductor L₁ and a resistor R₁. The portable electronic device 204 includes an inductor L₂ through which a current I₂ is induced to flow through a resistor R₂ based on the magnetic field generated through the inductor L₁. Therefore, the inductor L₁ in the wireless charger 202 and the inductor L₂ in the portable electronic device 204 collectively form a transformer 208. As a result, a voltage V_{CHG} is provided to the portable electronic device 204 to power the portable electronic device 204 and/or charge a battery (not shown) within the portable electronic device 204.

As an example, it may be necessary or desirable for the portable electronic device 204 to communicate with the wireless charger 202. As an example, the portable electronic device 204 may provide messages to the wireless charger 202 to indicate that it is receiving power from the wireless charger 202, to indicate that it is fully charged, or to provide any of a variety of other indications. In the example of FIG. 5, the portable electronic device 204 includes a bi-phase modulation transmitter 210 that is coupled to a switch S₂. The bi-phase modulation transmitter 210 can thus open and close the switch S₂ to modulate a bi-phase modulation signal into the current I₂, such that the opening and closing of the switch provides logic-low and logic-high states, respectively, of the current I₂. Because power in the wireless power system 200 is conserved, the bi-phase modulation signal that is modulated onto the current I₂ is likewise modulated onto the current I₁ through the inductive coupling of the transformer 208.

The wireless charger 202 includes a receiver 212 that is coupled to the current path of the current supply 206, the inductor L₁, and the resistor R₁. The receiver 212 is thus configured to monitor the primary current I₁, and thus to demodulate the bi-phase modulated signal from the primary current I₁. As an example, the receiver 212 can monitor a voltage, power, or the primary current I_{I} itself to demodulate the bi-phase modulated signal. Specifically, the receiver 212 includes an ADC 214 that is configured to generate digital samples at a substantially constant frequency, with the digital samples corresponding to the magnitude of the primary current I₁ or an associated voltage or power, and thus the bi-phase modulated signal. The receiver 212 also includes a bi-phase modulation decoder 216. As an example, the bi-phase modulation decoder 216 can be configured substantially similar to the bi-phase modulation decoder 10 in the example of FIG. 1 or the bi-phase modulation decoder 150 in the example of FIG. 4. Therefore, the bi-phase modulation decoder 216 is configured to decode the digital samples of the current I₁ generated from the ADC 214 and to generate an output signal CODE_OUT.

It is to be understood that the wireless power system 200 is not intended to be limited to the example of FIG. 5. Specifically, the wireless power system 200 is demonstrated simplistically, such that a variety of additional circuit and/or communication components have been omitted from the example of FIG. 5. As an example, the circuits through which the currents I₁ and I₂ flow can include any of a variety of additional circuit components, such as arrangements of resistors and/or capacitors for providing the voltage V_{CHG}. As another example, the bi-phase modulation transmitter 210 can be provided commands from or can be configured as part of a processor (not shown). Furthermore, the wireless power system 200 can include any of a variety of additional devices for providing and/or receiving power, such as additional portable electronic devices being inductively coupled to additional inductors. Accordingly, the wireless power system 200 can be configured in any of a variety of ways.

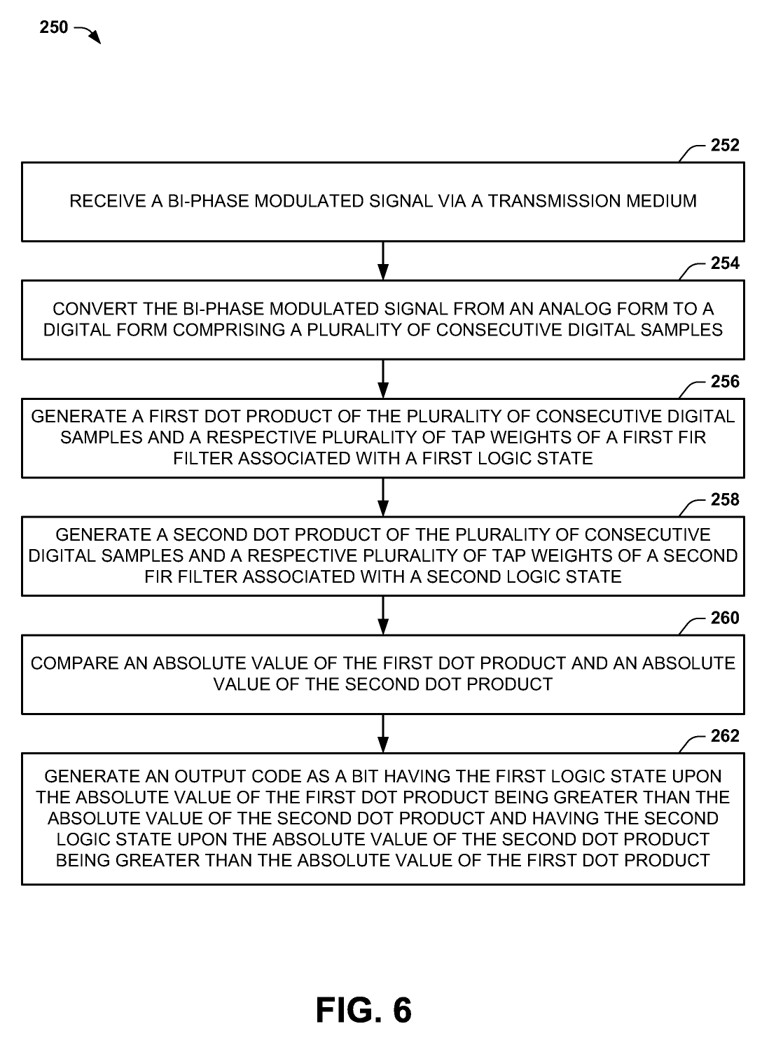

In view of the foregoing structural and functional features described above, a methodology in accordance with various aspects of the present invention will be better appreciated with reference to FIG. 6. While, for purposes of simplicity of explanation, the methodology of FIG. 6 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 6 illustrates an example of a method 250 for decoding a bi-phase modulated signal in accordance with an aspect of the invention. At 252, the bi-phase modulated signal is received via a transmission medium. The transmission medium could be a wireless medium or a wired medium, such as a current flow through a primary inductor of a transformer in a wireless power system. At 254, the bi-phase modulated signal is converted from an analog form to a digital form comprising a plurality of consecutive digital samples. The conversion can result from an ADC having a sampling rate that is higher than a frequency of the bi-phase modulated signal, thus resulting in an expected number of digital samples per bit-window.

At 256, a first dot product of the plurality of consecutive digital samples and a respective plurality of tap weights of a first finite impulse response filter associated with a first logic-state is generated. The tap weights can be arranged such that they can be plotted as an approximate half sine wave across the taps, with all tap weights being greater than or equal to a reference value (e.g., zero). At 258, a second dot product of the plurality of consecutive digital samples and a respective plurality of tap weights of a second finite impulse response filter associated with a second logic-state is generated. The tap weights can be arranged such that they can be plotted as an approximate sine wave across the taps, with a first portion of consecutive taps having tap weights greater than the reference value and a second portion of consecutive taps having tap weights less than the reference value. The first and second filters could be first and second pluralities of filters, with each filter having a distinct number of taps in each plurality.

At 260, an absolute value of the first dot product and an absolute value of the second dot product are compared. At 262, an output code is generated as a bit having the first logic-state upon an absolute value of the first dot product being greater than an absolute value of the second dot product and having the second logic-state upon the absolute value of the second dot product being greater than the absolute value of the first dot product. The determination of the greatest absolute value dot product could also provide an indication of a size of a bit-window based on frequency variation and/or jitter.

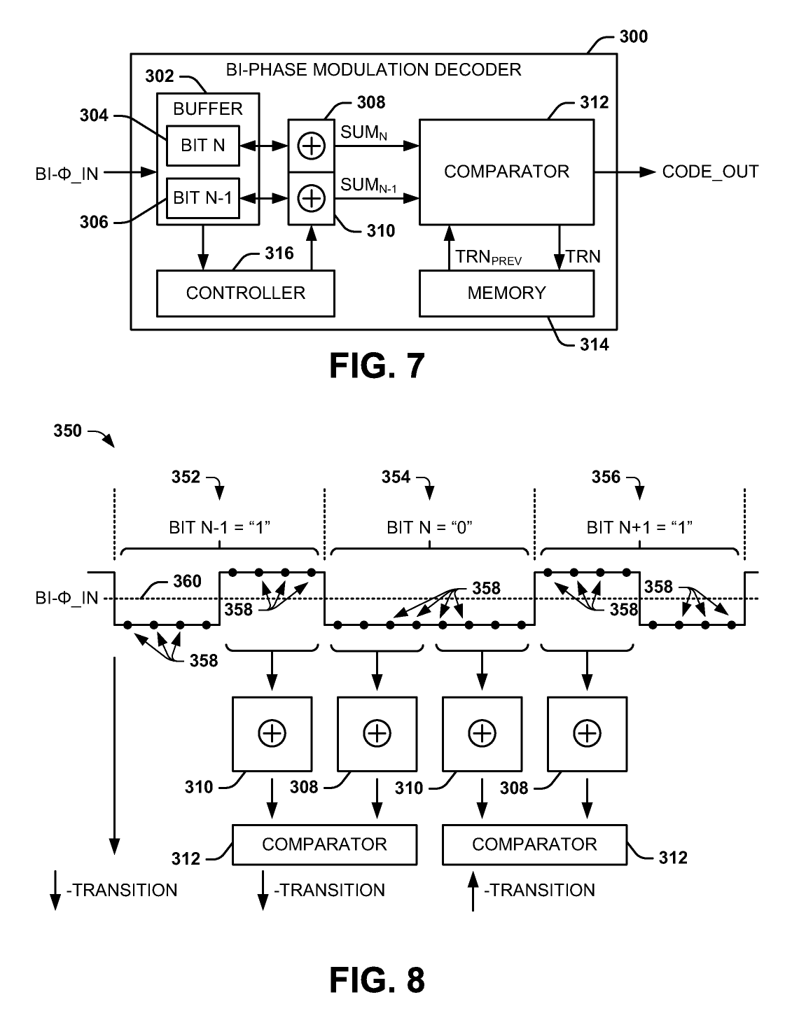

FIG. 7 illustrates yet another bi-phase modulation decoder 300 in accordance with an aspect of the invention. The bi-phase modulation decoder 300 is configured to receive a bi-phase modulated signal BI-Φ_IN and to decode the bi-phase modulated signal BI-Φ_IN to generate an output code CODE_OUT. Each bit-window of the bi-phase modulated signal BI-Φ_IN can represent a single logic bit, with each bit-window beginning with a logic-state edge-transition. A logic-low can be represented by a substantially constant logic-state through the bit-window, whereas a logic-high can be represented by an additional logic-state edge-transition in the approximate center of the bit-window. The bi-phase modulation decoder 300 can be implemented in any of a variety of electronic communications applications. As an example, the bi-phase modulation decoder 300 can be included in a receiver in a wireless power application.

The bi-phase modulation decoder 300 includes a buffer 302 configured to store the digital samples associated with the bi-phase modulated signal BI-Φ_IN sequentially. As an example, the bi-phase modulated signal BI-Φ_IN can be provided to have eight digital samples corresponding to each bit, such as based on a clock associated with an upstream ADC (not shown). Thus, for example, the buffer 302 can be configured to store ten digital samples of the bi-phase modulated signal BI-Φ_IN at a given time, such that the buffer 302 can be configured to store a number of samples that is greater than a number of digital samples corresponding to a single bit but less than the number of samples corresponding to two bits. Alternatively, it is to be understood that the bi-phase modulated signal BI-Φ_IN can be represented by more or less than eight digital samples per bit, and the buffer 302 can be configured to store any number of samples that is greater than or equal to the number of samples representing a single bit.

The digital samples that are stored in the buffer 302 can correspond to a portion of a total number of digital samples of each of two consecutive bits of the bi-phase modulated signal BI-Φ_IN. In the example of FIG. 7, the two consecutive bits of the bi-phase modulated signal BI-Φ_IN are demonstrated as bit N at 304 and bit N−1 at 306, with bit N−1 immediately preceding bit N. Thus, the digital samples that are stored in the buffer 302 can be a portion of the total digital samples for each of the bits N and N−1 that are symmetrically arranged on either side of an edge-transition between the bits N and N−1. As an example, the portion of the digital samples of the bit N that are stored in the buffer 302 can be associated with the first half of the digital samples of the bit N, and the portion of the digital samples of the bit N−1 that are stored in the buffer 302 can be associated with the second half of the digital samples of the bit N−1. For example, for the bits N and N−1 being represented by eight digital samples, the buffer 302 can include at least the four digital samples of the second half of the bit N−1 and the four digital samples of the first half of the bit N.

The bi-phase modulation decoder 300 also includes a first summer 308 and a second summer 310. As an example, the summers 308 and 310 can be configured as software or a combination of hardware and software components in the bi-phase modulation decoder 300. The first summer 308 is configured to add together a subset of the portion of the digital samples of the bit N to generate a first sum SUM_{N} and the summer 310 is configured to add together a subset of the portion of the digital samples of the bit N−1 to generate a second sum SUM_{N-1}. For example, the first summer 308 can add together all four of the digital samples of the first half of the bit N for an eight digital sample bit of the bi-phase modulated signal BI-Φ_IN, and the second summer 310 can thus add together all four of the digital samples of the second half of the bit N−1. As another example, the first summer 308 can add together less than all four of the digital samples of the first half of the bit N for an eight digital sample bit of the bi-phase modulated signal BI-Φ_IN, such that the second summer 310 can thus add together a corresponding and symmetrically located number of digital samples of the second half of the bit N−1.

The sums SUM_{N} and SUM_{N-1} that are generated by the summers 308 and 310, respectively, are provided to a comparator 312. The comparator 312 can thus compare the sums SUM_{N} and SUM_{N-1} corresponding to the portions of digital samples of the bits N and N−1 to determine the edge-transition between the bits N and N−1. Specifically, if the sum SUM_{N} is greater than the sum SUM_{N-1}, then the edge-transition between the bits N and N−1 is logic-high (i.e., a rising-edge). Similarly, if the sum SUM_{N} is less than the sum SUM_{N-1}, then the edge-transition between the bits N and N−1 is logic-low (i.e., a falling-edge). In the example of FIG. 7, the comparator 312 stores the edge-transition in a memory 314 via a signal TRN, such that the comparator 312 can subsequently use the edge-transition to decode the bit N.

The comparator 312 can then compare the edge-transition between the bits N and N−1 with an immediately preceding edge-transition, specifically the edge-transition between the bit N−1 and the immediately preceding bit, to determine the whether the bit N−1 corresponds to a logic-low or a logic-high output code. In the example of FIG. 7, the immediately preceding edge-transition is stored in the memory 314 and is provided to the comparator 312 via a signal TRNPREV. Thus, if the edge-transition between the bits N and N−1 is the same as the immediately preceding edge-transition, then the comparator 312 identifies that the bit N−1 corresponds to a logic-high code. However, if the edge-transition between the bits N and N−1 is the opposite from the immediately preceding edge-transition, then the comparator 312 identifies that the bit N−1 corresponds to a logic-low code. The comparator 302 then provides the output code of the bit N−1 as the output signal CODE_OUT.

FIG. 8 illustrates an example diagram 350 of decoding a bi-phase modulated signal BI-Φ_IN in accordance with an aspect of the invention. The diagram 350 can correspond to a decoding operation performed by the bi-phase modulation decoder 300 in the example of FIG. 7 above. Thus, reference is to be made to the example of FIG. 7 in the following description of the example of FIG. 8.

The bi-phase modulated signal BI-Φ_IN is demonstrated as including three bit-windows, a first bit-window 352 that corresponds to a bit N−1 having a logic-high code, a second bit-window 354 that corresponds to a bit N having a logic-low code, and a third bit-window 356 that corresponds to a bit N+1 having a logic-high code. Specifically, the bit-windows 352, 354, and 356 are each separated by a logic-state edge-transition, with the first and third bit-windows 352 and 356 corresponding to logic-high codes based on including an additional logic-state edge-transition in the approximate center of each of the bit-windows. Each of the bit-windows 352, 354, and 356 are represented by eight digital samples 358, which can be based on a clock speed of an associated ADC. Thus, the logic-high and logic-low codes are based on the magnitude of the digital samples 358 relative to a zero-crossing magnitude 360. It is to be understood that the zero-crossing magnitude 360 is not limited to having a magnitude of zero, but could have a magnitude that is approximately half of a difference between the digital samples 358 corresponding to logic-high values and the digital samples 358 corresponding to logic-low values.

The buffer 302 is configured to continuously store the consecutive digital samples 358. To decode the logic-state of the bit N−1, the first summer 308 can add together the digital samples 358 corresponding to the first half of the bit N and the second summer 310 can add together the digital samples 358 corresponding to the second half of the bit N−1. The comparator 312 can then compare the sums SUM_{N} and SUM_{N-1} to determine if the edge-transition between the bit N and the bit N−1 is a rising-edge transition or a falling-edge transition. Because the sum of the digital samples 358 corresponding to the first half of the bit N is less than the sum of the digital samples 358 corresponding to the second half of the bit N−1, based on the relative magnitudes of the respective digital samples 358, the comparator 312 can thus determine that the edge-transition between the bits N and N−1 is a falling-edge transition. The comparator 312 can thus determine that the bit N−1 has a logic-high (i.e., “1”) code because the edge-transition between the bits N and N−1 is the same as the edge-transition between the bit N−1 and the immediately preceding bit. The comparator 312 can then add the “1” value corresponding to the bit N−1 serially to the output code CODE_OUT.

Upon determining the output code associated with the bit N−1, the buffer 302 can shift unused digital samples 358 to one end of the buffer 302 and store the next set of consecutive digital samples 358 of the bi-phase modulated signal BI-Φ_IN. For example, the buffer 302 can move or shift the unused digital samples 358 to a respective set of furthest left cells and can overwrite previous digital samples or empty cells of the buffer 302 with the next consecutive digital samples 358 of the bi-phase modulated signal BI-Φ_IN. As one example, based on the selected samples that were added together by the summers 308 and 310, it can be determined which of the digital samples 358 are used for the determination of the output code of the bit N. As another example, the digital samples 358 to be used for the determination of the output code of the bit N can be determined in a different way, as described in greater detail below.

To decode the logic-state of the bit N, the first summer 308 can add together the digital samples 358 corresponding to the first half of the bit N+1 and the second summer 310 can add together the digital samples 358 corresponding to the second half of the bit N. The comparator 312 can then compare the sums SUM_{N} and SUMN−1 to determine the edge-transition between the bit N and the bit N+1. Because the sum of the digital samples 358 corresponding to the first half of the bit N+1 is greater than the sum of the digital samples 358 corresponding to the second half of the bit N, the comparator 312 can thus determine that the edge-transition between the bits N and N+1 is a rising-edge transition. The comparator 312 can thus determine that the bit N has a logic-low (i.e., “0”) code because the edge-transition between the bits N and N+1 is opposite the edge-transition between the bits N and N−1, as determined previously by the comparator 312. The comparator 312 can then add the “0” value corresponding to the bit N serially to the output code CODE_OUT. The bi-phase modulation decoder 300 can thus continue to decode the bi-phase modulation signal BI-Φ_IN in the manner described herein.

Such manner of decoding the bi-phase modulation signal BI-Φ_IN, as described in the examples of FIGS. 7 and 8, can thus result in a more efficient manner of decoding the bi-phase modulated signal BI-Φ_IN. In other words, the bi-phase modulation decoder 300 in the example of FIG. 7 uses less MIPS than the bi-phase modulation decoders 10 and 150 in the examples of FIGS. 1 and 4, respectively, based on simpler math performed by the associated processor. Specifically, the bi-phase modulation decoder 300 can implement approximately eight add instructions and one compare instruction to decode the bi-phase modulated signal BI-Φ_IN, whereas the bi-phase modulation decoder 150 in the example of FIG. 4 can implement approximately fifty multiply instructions and fifty add instructions.

Referring back to the example of FIG. 7, the bi-phase modulation decoder 300 can also include a controller 316 configured to select a subset of the digital samples of the bi-phase modulated signal BI-Φ_IN to be provided to the first and second summers 308 and 310. As an example, the controller 316 can be configured to selectively discard one or more of the digital samples of the bit N and a corresponding to number of the digital samples of the bit N−1 that are symmetrically located with respect to the edge-transition between the bits N and N−1 to substantially compensate for asymmetry of the bi-phase modulated signal BI-Φ_IN. As another example, as described above with respect to the example of FIG. 4, the number of samples that can correspond to a given bit-window of the bi-phase modulation signal BI-Φ_IN may vary based on frequency variation and/or jitter resulting from a lack of an external clock to align the frequency of the bi-phase modulated signal BI-Φ_IN and the sampling frequency of the associated ADC. Therefore, the controller 316 can be configured as an integrator to selectively discard one or more of the digital samples associated with one or both of the bits N and N−1 to substantially account for variation in the number of digital samples of the bi-phase modulated signal BI-Φ_IN.

FIG. 9 illustrates another example diagram 400 of decoding a bi-phase modulated signal in accordance with an aspect of the invention. The diagram 400 can correspond to a decoding operation performed by the bi-phase modulation decoder 300 in the example of FIG. 7 above. Thus, reference is to be made to the example of FIG. 7 in the following description of the example of FIG. 9.

The bi-phase modulated signal BI-Φ_IN is demonstrated as including a second half of a bit-window 402 associated with a bit N−1 having a logic-high code and a first half of a bit window 404 associated with a bit N also having a logic-high code. Thus, the diagram 400 demonstrates a total of eight digital samples 406, numbered from 0 to 7, that can be implemented by the bi-phase modulation decoder 300 to determine the output code of the bit N−1, which can be based on a clock speed of an associated ADC. In the example of FIG. 9, the magnitudes of the digital samples 406 can be based on a relative to a zero-crossing magnitude 408, which is demonstrated in the example of FIG. 9 as having the digital value of “0”. The diagram 400 also includes the buffer 302 which demonstrates the digital values of each of the eight digital samples 406. Specifically, in the example of FIG. 9, the digital samples 406 numbered 0 and 3 have digital values of −50, the digital samples 406 numbered 1 and 2 have digital values of 80, and the digital samples 406 numbered 4 through 7 have digital values of −100.

As described above, the bi-phase modulated signal BI-Φ_IN may be asymmetric, such that the rising-edge transitions and/or the falling-edge transitions may be early or late relative to each other. Such asymmetry can result from factors such as noise, temperature, or any of a variety of other factors. As a result, the digital samples of the bi-phase modulated signal BI-Φ_IN may favor either positive or negative values on either side of an expected edge-transition 410. In the example of FIG. 9, the rising-edge in the approximately center of the bit-window 402 is demonstrated as approximately late and the falling-edge transition between the bits N and N−1 is demonstrated as approximately early. As a result, the digital values of the digital samples 406 favor negative values, such that a comparison of the sums SUM_{N} and SUMN−1 for the digital samples of each of the bits N and N−1 could result in a false determination of whether the edge-transition of the bi-phase modulated signal BI-Φ_IN between the bits N and N−1 is a rising-edge transition or a falling-edge transition.

To substantially mitigate the deleterious effects of an asymmetric property of the bi-phase modulated signal BI-Φ_IN, the controller 316 can be configured to selectively discard one or more samples from each of the bits N and N−1 in a symmetric manner about the expected edge-transition 410. Specifically, the controller 316 can be configured to specify which of the digital samples 406 that the summers 308 and 310 add together to generate the respective sums SUM_{N} and SUMN−1. In the example of FIG. 9, the controller specifies that the digital samples 406 numbered 0 and 7, which are symmetrical about the expected edge-transition 410. Thus, the first summer 308 adds together the digital samples 406 numbered 4 through 6 and the second summer 310 adds together the digital samples 406 numbered 1 through 3. As a result, the possible negative effects on determining the edge-transition between the bits N and N−1 can be substantially mitigated. In addition, it is to be understood that the controller 316 can be configured to selectively discard different digital samples 406 or more than one digital sample 406 from each of the bits N and N−1. For example, the controller 316 can be configured to alternatively or additionally discard the digital samples 406 numbered 3 and 4, such that the first summer 308 adds together the digital samples 406 numbered 1 and 2 or the digital samples 406 numbered 0 through 3 and the second summer 310 adds together the digital samples 406 numbered 5 and 6 or the digital samples 406 numbered 5 through 7.

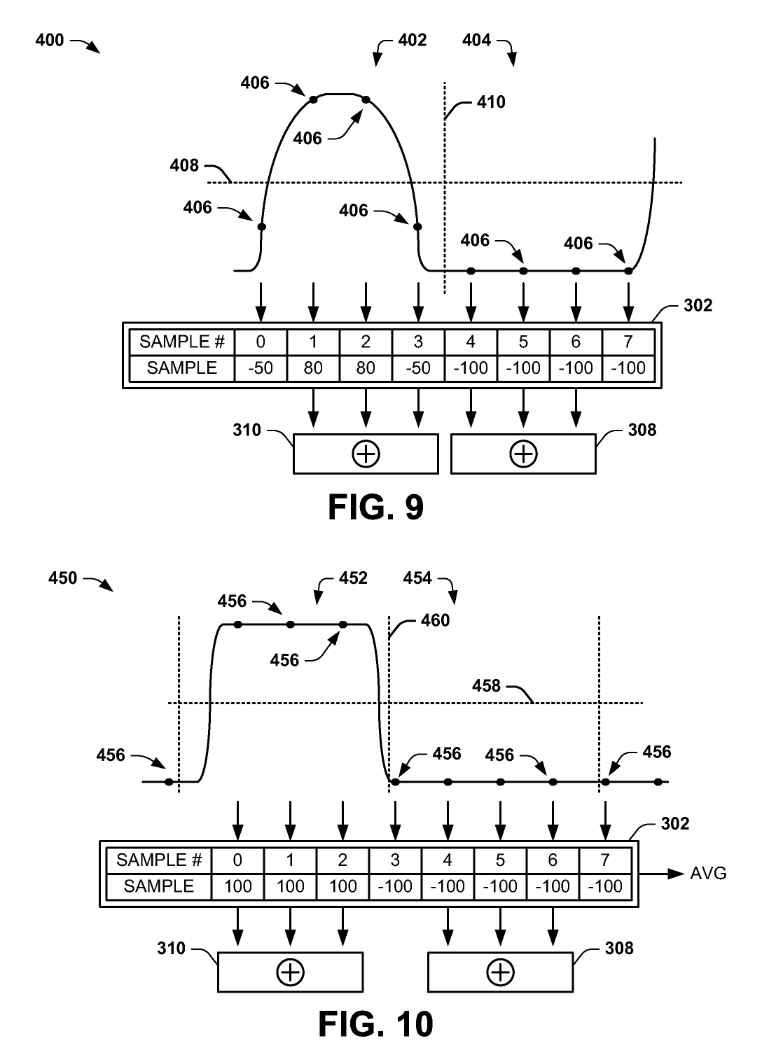

FIG. 10 illustrates yet another example diagram 450 of decoding a bi-phase modulated signal in accordance with an aspect of the invention. The diagram 450 can correspond to a decoding operation performed by the bi-phase modulation decoder 300 in the example of FIG. 7 above. Thus, reference is to be made to the example of FIG. 7 in the following description of the example of FIG. 10.

The bi-phase modulated signal BI-Φ_IN is demonstrated as including a second half of a bit-window 452 associated with a bit N−1 having a logic-high code and a first half of a bit window 454 associated with a bit N also having a logic-high code. Thus, the diagram 450 demonstrates a total of eight digital samples 456, numbered from 0 to 7, that can be implemented by the bi-phase modulation decoder 300 to determine the output code of the bit N−1, which can be based on a clock speed of an associated ADC. In the example of FIG. 10, the magnitudes of the digital samples 456 can be based on a relative to a zero-crossing magnitude 458, which is demonstrated in the example of FIG. 10 as having the digital value of “0”. The diagram 450 also includes the buffer 302 which demonstrates the digital values of each of the eight digital samples 456. Specifically, in the example of FIG. 10, the digital samples 456 numbered 0 through 2 have digital values of 100 and the digital samples 456 numbered 3 through 7 have digital values of −100.

As described above, the number of samples that can correspond to a given bit-window of the bi-phase modulation signal BI-Φ_IN may vary based on frequency variation and/or jitter resulting from a lack of an external clock to align the frequencies of the bi-phase modulated signal BI-Φ_IN and the sampling frequency of the associated ADC. Thus, in the example of FIG. 10, the bit N−1 is demonstrated as having only the first three digital samples 456 (i.e., numbered 0 through 2) of the set of eight digital samples 456 stored in the buffer based on an expected edge-transition 460, such that the bit N−1 may have only had seven digital samples. As a result, the controller 316 can be configured to determine the location of the actual edge-transition between the bits N and N−1 based on the digital values of the digital samples 456 as stored in the buffer 302. Thus, the controller 316 can ascertain the number of digital samples 456 that corresponds to the bit N−1 to properly determine the edge-transition between the bits N and N−1.

As an example, the controller 316 can generate an average AVG of the eight digital samples 456 that correspond to the eight digital samples 456 that are expected to correspond to the respective bits N and N−1. The average AVG of the eight digital samples 456 can correspond to a threshold. Thus, the controller 316 can be configured to generate another average of the values of the digital samples 456 numbered 3 and 4 corresponding to an expected edge-transition. As a result, a comparison of the average of the values of the digital samples 456 numbered 3 and 4 relative to the average AVG of the eight digital samples 456 can be determinative of whether the edge-transition was early or late relative to the expected edge-transition. In the example of FIG. 10, the controller 316 can determine that the average AVG of the eight digital samples 456 has a value of “−25”, and that the average of the values of the digital samples 456 numbered 3 and 4 has a value of “−100”. Therefore, because the average of the values of the digital samples 456 numbered 3 and 4 is less than the average AVG of the eight digital samples 456, the controller 316 can determine that the edge-transition was earlier than expected.

As a result of the determination of the relative location of the edge-transition, the controller 316 can ascertain that the bit N−1 does not include the expected number of digital samples (e.g., eight digital samples 456 in the example of FIG. 10). Therefore, the controller 316 can be configured to selectively discard one or more of the digital samples 456 to provide symmetry between the digital samples 456 corresponding to the bit N and the bit N−1, respectively. As an example, the controller 316 can determine how many of the digital samples 456 to selectively discard based on an integral gain K to adjust a sample count, such as to use the difference between the average of the values of the digital samples 456 numbered 3 and 4 and the average AVG of the eight digital samples 456. Thus, in the example of FIG. 10, the controller 316 can set the integral gain K such that the new number of digital samples 456 used for the determination of the value of the bit N−1 can be equal to the previous number of the digital samples 456 plus the integral gain K times the difference between the average of the values of the digital samples 456 numbered 3 and 4 and the average AVG of the eight digital samples 456. For example, the integral gain K can be set equal to 0.01, such that:

Samples_{NEW}=Samples_{OLD}*K*(AVG_{TRAN}*AVG) Equation 1
Where: Samples_{NEW} corresponds to the new number of digital samples used for the determination of the value of the bit N−1;
Samples_{OLD} corresponds to the previous number of the digital samples used for the determination of the value of the bit N−1;
AVG_{TRAN} corresponds to the average of the values of the digital samples of the expected edge-transition.
   It is to be understood that, in the event that the controller 316 has determined that the current bit-window has an odd-number of samples, the controller 316 can simply use the value of the median digital sample (e.g., sample “3” of seven digital samples), as opposed to the average AVG_{TRAN} between the digital samples of the expected edge-transition.

Thus, in the example of FIG. 10, the controller 316 can determine that Samples_{NEW} can be equal to “7.25”. As a result, the controller 316 can determine that the next set of digital sample 456 to be used for determining the value of the bit N−1 can be seven. Accordingly, the controller 316 can update the number of digital samples 456 for the next bit-window to be seven, such as by updating the buffer 302 with the next set of digital samples 456. For example, the controller 316 can move the digital sample 456 number 7 to the leftmost position in the buffer (i.e., number 0), and collect six more digital samples 456 to be used for the next edge-transition determination.

Accordingly, for the next edge-transition determination, the controller 316 can discard the digital sample 456 number 3 based on that digital sample 456 being the odd-numbered digital sample 456 closest to the edge-transition between the bits N and N−1. Thus, the first summer 308 adds together the digital samples 406 numbered 0 through 2 and the second summer 310 adds together the digital samples 406 numbered 4 through 6. In addition, the controller 316 can then identify that the digital sample 456 numbered 7 corresponds to the second half of the bit N, such that the digital sample 456 numbered 7 can be saved in the buffer 302 (e.g., moved to the number 0 cell in the buffer 302) to be used to subsequently determine the output code of the bit N. Accordingly, the controller 316 can operate as an integrator to ensure that the bi-phase modulation decoder 300 can correctly decode the bi-phase modulation signal BI-Φ_IN regardless of mismatch between the frequency of the bi-phase modulated signal BI-Φ_IN and the sampling frequency of the associated ADC.

It is to be understood that the bi-phase modulation decoder 300 is not intended to be limited to the examples of FIGS. 7-10. As an example, while the bi-phase modulated signal BI-Φ_IN is demonstrated as having a sampling frequency that results in eight digital samples per bit-window, it is to be understood that the bi-phase modulated signal BI-Φ_IN can be sampled at any of a variety of frequencies to provide a more or less than eight digital samples per bit-window. As another example, it is to be understood that the selective discarding of digital samples from the buffer 302 demonstrated in the examples of FIGS. 9 and 10 can be implemented separately, or they can be implemented together to substantially mitigate miscalculation of the edge-transition between the bits N and N−1 based on both asymmetry and frequency mismatch. Therefore, the bi-phase modulation decoder can be configured in any of a variety of ways.

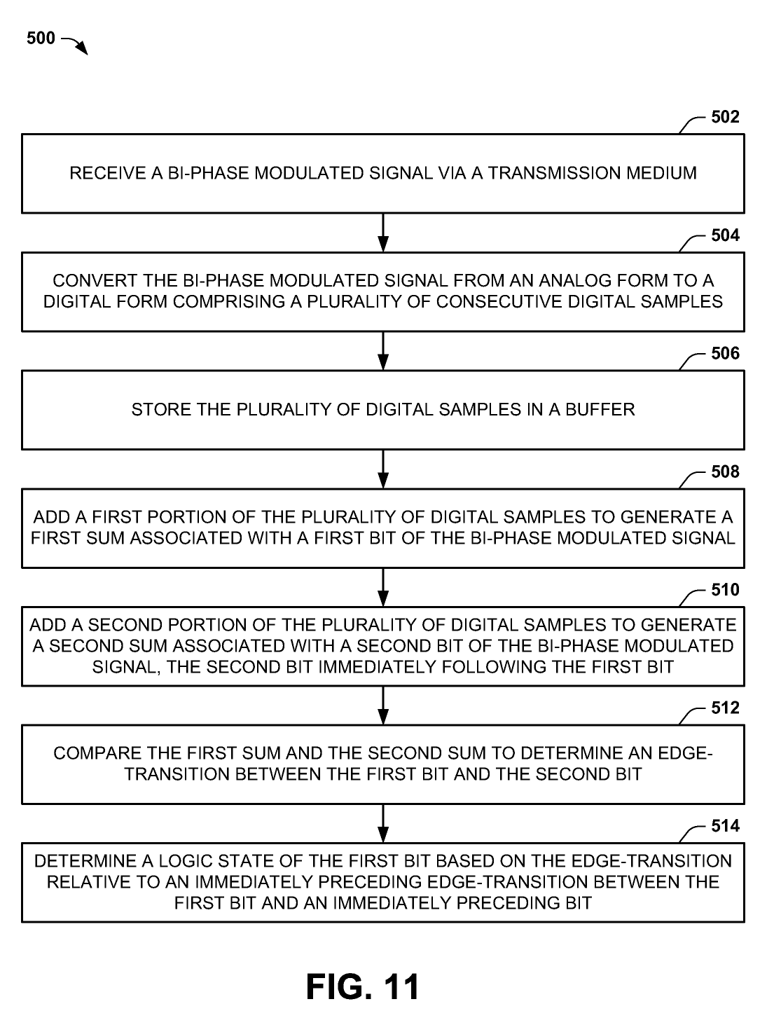

FIG. 11 illustrates another example of a method 500 for decoding a bi-phase modulated signal in accordance with an aspect of the invention. At 502, the bi-phase modulated signal is received via a transmission medium. The transmission medium could be a wireless medium or a wired medium, such as a current flow through a primary inductor of a transformer in a wireless power system. At 504, the bi-phase modulated signal is converted from an analog form to a digital form comprising a plurality of consecutive digital samples. The conversion can result from an ADC having a sampling rate that is higher than a frequency of the bi-phase modulated signal, thus resulting in an expected number of digital samples per bit-window.

At 506, the plurality of digital samples are stored in a buffer. The digital samples can be stored consecutively, and the buffer can include a number of cells for storing digital samples that is greater than or equal to the number of digital samples in a given bit-window of the bi-phase modulated signal. At 508, a first portion of the plurality of digital samples is added to generate a first sum associated with a first bit of the bi-phase modulated signal. The first portion of the digital samples can include less than or equal to all of the digital samples corresponding to the second half of the first bit. At 510, a second portion of the plurality of digital samples is added to generate a second sum associated with a second bit of the bi-phase modulated signal, the second bit immediately following the first bit in the bi-phase modulated signal. The second portion of the digital samples can include less than or equal to all of the digital samples corresponding to the first half of the second bit.

At 512, the first sum and the second sum are compared to determine an edge-transition between the first bit and the second bit. The edge-transition can be determined to be a rising-edge transition if the second sum is greater than the first sum, and can be determined to be a falling-edge transition if the first sum is greater than the second sum. At 514, a logic-state of the first bit is determined based on the edge-transition relative to an immediately preceding edge-transition between the first bit and an immediately preceding bit. The logic-state can be determined to be a logic-high state if the edge-transition is the same as an immediately preceding edge-transition, and can be determined to be a logic-low state if the edge-transition is opposite from an immediately preceding edge-transition.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A decoder system that decodes a bi-phase modulated signal, the system comprising:
a buffer configured to store a first plurality of digital samples associated with a first bit of the bi-phase modulated signal and a second plurality of digital samples associated with a second bit of the bi-phase modulated signal, the first bit immediately preceding the second bit;
a first summer configured to add the first plurality of digital samples to generate a first sum;
a second summer configured to add the second plurality of digital samples to generate a second sum; and
a comparator configured to compare the first sum and the second sum to determine an edge-transition between the first bit and the second bit, and to determine a logic-state of the first bit based on the edge-transition.

2. The system of claim 1, wherein the first plurality of digital samples comprise a plurality of samples associated with a second half of a total number of samples associated with the first bit and wherein the second plurality of digital samples comprise a plurality of samples associated with a first half of a total number of samples associated with the second bit.

3. The system of claim 2, wherein the total number of samples associated with each of the first and second bits comprises X bits, where X is a positive integer, and wherein the plurality of samples associated with each of the second half and the first half of the total number of samples associated with each of the first and second bits, respectively, comprises Y bits, where Y is a positive integer that is less than X/2 bits, rounded down.

4. The system of claim 1, wherein the buffer is configured to store a total plurality of digital samples that comprises the first and second pluralities of digital samples, the system further comprising a controller configured to identify a quantity of the total plurality of digital samples that correspond to a given bit of the bi-phase modulated signal.

5. The system of claim 4, wherein the integrator is configured to identify the quantity of the total plurality of digital samples that correspond to the given bit of the bi-phase modulated signal based on an average of digital samples comprising the first and second pluralities of digital samples relative to one of a median digital sample and an average of a pair of digital samples that correspond to an expected location of the edge-transition between the first and second bits associated with the first and second pluralities of digital samples.

6. The system of claim 5, wherein the integrator is configured to determine a location of the edge-transition between two consecutive digital samples of the total plurality of digital samples based on the average.

7. The system of claim 6, wherein the integrator is further configured to determine which of the total plurality of digital samples stored in the buffer correspond to the first plurality of digital samples and the second plurality of digital samples, respectively, based on the location of the edge-transition.

8. The system of claim 1, wherein an output of the comparator is determinative of the logic-state of the second bit based on the edge-transition by comparing the edge-transition with a previous edge-transition between the first bit and an immediately preceding bit.

9. The system of claim 8, wherein the comparator is configured to determine that the second bit has a logic-high state based on the edge-transition being substantially equal to the previous edge-transition and to determine that the second bit has a logic-low state based on the edge-transition being opposite of the previous edge-transition.

10. A wireless power system comprising the decoder system of claim 1, the wireless power system comprising:
a wireless charger comprising a receiver configured to monitor a primary current associated with a primary inductor, the receiver comprising the decoder system of claim 1; and
a portable electronic device comprising a transmitter configured to modulate the bi-phase communication signal onto a secondary current associated with a secondary inductor, the primary inductor and secondary inductor collectively forming an isolation transformer configured to transfer energy from the primary inductor to the secondary inductor to generate a voltage in the portable electronic device.

11. The wireless power system of claim 10, the receiver further comprising an analog-to-digital converter (ADC) configured to convert a magnitude of one of a voltage, a power, and a current associated with the primary inductor into the plurality of digital samples of the bi-phase modulated signal.

12. A method for decoding a bi-phase modulated signal, the method comprising:
receiving the bi-phase modulated signal via a transmission medium;
converting the bi-phase modulated signal from an analog form to a digital form comprising a plurality of digital samples;
storing the plurality of digital samples in a buffer;
adding a first portion of the plurality of digital samples to generate a first sum associated with a first bit of the bi-phase modulated signal;
adding a second portion of the plurality of digital samples to generate a second sum associated with a second bit of the bi-phase modulated signal, the second bit immediately following the first bit in the bi-phase modulated signal;
comparing the first sum and the second sum to determine an edge-transition between the first bit and the second bit; and
determining a logic-state of the first bit based on the edge-transition relative to an immediately preceding edge-transition between the first bit and an immediately preceding bit.

13. The method of claim 12, wherein adding the first portion of the plurality of digital samples comprises adding the first portion of the plurality of digital samples associated with a second half of a total number of samples associated with the first bit to generate the first sum, and wherein adding the second portion of the plurality of digital samples comprises adding the second portion of the plurality of digital samples associated with a first half of a total number of samples associated with the second bit to generate the second sum.

14. The method of claim 13, further comprising discarding at least one sample from the first and second portions of the plurality of digital samples symmetrically about the edge-transition prior to adding the first portion to generate the first sum and adding the second portion to generate the second sum.

15. The method of claim 12, further comprising generating an average of an expected number of samples corresponding to the first and second pluralities of digital samples to determine a quantity of the plurality of digital samples that correspond to a given bit of the bi-phase modulated signal.

16. The method of claim 15, further comprising:
determining a location of the edge-transition between two consecutive digital samples of the plurality of digital samples based on the average; and
determining which of the plurality of digital samples stored in the buffer correspond to the first plurality of digital samples and the second plurality of digital samples, respectively, based on the location of the edge-transition.

17. A wireless power system comprising:
a portable electronic device comprising a transmitter configured to modulate a bi-phase communication signal onto a secondary current associated with a secondary inductor; and
a wireless charger comprising a receiver configured to monitor a primary current associated with a primary inductor, the primary inductor and secondary inductor collectively forming an isolation transformer configured to transfer energy from the primary inductor to the secondary inductor to generate a voltage in the portable electronic device, the receiver comprising a decoder comprising:
a buffer configured to store a first plurality of digital samples associated with a second half of a total number of samples of a first bit of the bi-phase modulated signal and a second plurality of digital samples associated with a second half of a total number of samples of a second bit of the bi-phase modulated signal, the first bit immediately preceding the second bit;
a first summer configured to add the first plurality of digital samples to generate a first sum;
a second summer configured to add the second plurality of digital samples to generate a second sum; and
a comparator configured to compare the first sum and the second sum to determine an edge-transition between the first bit and the second bit, and to determine a logic-state of the second bit based on comparing the edge-transition with a previous edge-transition between the first bit and an immediately preceding bit.

18. The wireless power system of claim 17, the receiver further comprising an analog-to-digital converter (ADC) configured to convert a magnitude of the primary current into the plurality of consecutive digital samples of the bi-phase modulated signal.

19. The wireless power system of claim 17, wherein the total number of samples associated with each of the first and second bits comprises X bits, where X is a positive integer, and wherein the plurality of samples associated with each of the second half and the first half of the total number of samples associated with each of the first and second bits, respectively, comprises Y bits, where Y is a positive integer that is less than X/2 bits, rounded down.

20. The wireless power system of claim 17, wherein the buffer is configured to store a total plurality of digital samples that comprises the first and second pluralities of digital samples, the system further comprising an integrator configured to identify a location of the edge-transition between two consecutive digital samples based on an average of digital samples comprising the first and second pluralities of digital samples, and to determine which of the total plurality of digital samples stored in the buffer correspond to the first plurality of digital samples and the second plurality of digital samples, respectively, based on the location of the edge-transition.
